(19) United States
(12) Patent Application Publication
(10) Pub. No.: US 2009/0324295 A1
(43) Pub. Date: Dec. 31, 2009

(54) METHOD AND DEVICE FOR THE REFILLING OF TONER POWDER

(75) Inventor: Mikael Håkansson, Malmo (SE)

Correspondence Address: YOUNG & THOMPSON, 209 Madison Street, Suite 500, Alexandria, VA, 22314, US

(73) Assignee: TMF SWEDEN AKTIEBOLAG, Svedala (SE)

(21) Appl. No.: 12/522,439

(22) PCT Filed: Jan. 8, 2008
(86) PCT No.: PCT/SE2008/050017

§ 371 Date: Jul. 10, 2009

(30) Foreign Application Priority Data
Jan. 8, 2007 (SE) 0700026-8
Mar. 28, 2008 (SE) 0700762-8

(51) Int. Cl. G03G 15/08

(52) U.S. Cl. 399/258

(57) ABSTRACT

A method for filling a toner cartridge, intended for duplication apparatus, with toner powder includes the steps of; placing the toner cartridge in relation to a device for refilling, inserting a hollow supply element through the passage in the cartridge and into the interior of the toner cartridge, which supply element is applied to a container containing toner powder and in flow communication with the interior of the container, and by feed element feed the powder from the container through the supply element and into the toner cartridge.

### TECHNICAL AREA

The present invention relates to a method and device for the refilling of toner powder och especially the refilling of toner cartridges designed to be used in duplication apparatuses such as printers, copy machines, fax machines and the like.

### TECHNICAL STANDPOINT

There are today a number of different devices for different types of printout e.g. fax machines, printers and copy machines. In the following description the word duplication apparatus will be used comprising these types of devices. It shall thereby be understood that all types of devices with toner are comprised by this word.

In such a device there is a container with the toner that constitutes the print on the sheet of paper. Generally this container is a plastic cartridge impervious to light which is exchanged for a full when the toner in it is depleted.

Some solutions for the recycling of cartridges when they are empty of toner powder have been developed.

JP 7 333 964 A, discloses a device for the refilling of toner comprising a container/bottle, which is screwed together with the threaded end of a pipe. The other threaded end of the pipe is screwed onto a threaded section of the toner cartridge.

EP 0578158 A2, discloses a device for the refilling of a cartridge, where a container with toner is connected to a cartridge via a supply conduit/spout. The device has a sort of sealing element which together with a spring closes the spout when pouring toner into the cartridge is over.

JP9006111 A, discloses a device for the refilling of toner in a cartridge, where the device is a balloon of sort with a supply conduit/opening which is specifically adapted to fit together with the opening of the cartridge. The toner falls down into the cartridge from the balloon.

The problem with above mentioned solutions are for one that there is a risk that the powder is spread in the surroundings when handled wrongly during refilling and/or that the cartridges have connecting/refilling devices that are specifically designed to be connected to the toner containers.

### SHORT DESCRIPTION OF THE INVENTION

The aim of the present invention is to provide a method and device for the refilling of toner powder in cartridges for duplication apparatuses anywhere such as stores etc. that provide a safe refilling of the cartridge with new toner powder without the risk of spreading powder.

This aim is solved with a method according to claim 1 and a device according to claim 10. Preferred embodiments of the invention form the subjects of the dependent claims.

According to a main aspect of the invention it is characterized by a method for filling a toner cartridge, intended for duplication devices, with toner powder, comprising the steps of positioning the toner cartridge in relation to a device for refilling, to, when the toner cartridge is to be refilled, create at least one passage through the casing of the toner cartridge, to insert a sealing and closing means in the passage, to insert a hollow supply means through the passage into the interior of the toner cartridge, which supply means is attached to a container containing toner powder and in flow communication with the interior of the container, and that with help from feed means supplying the powder from the container through the supply means and into the toner cartridge.

According to another aspect of the invention, it is characterized in that the step of creating a passage is executed with a passage forming means. This can have different designs such as a drill, stamper, needle tube or the like, where the passage forming means can be heated for the creation of the passage. The passage could also include a plug or insert with sealable opening. Plug refers to all possible means that can be inserted into the passage to grant sealing of it, such as a screw, a plastic- or rubber cork or the like.

According to one aspect the sealable opening can be of one-way lock type that allows insertion of the supply means and which seals the passage after the removal of the insertion means.

The feed means according to the invention can have several constructional solutions. For example it can include a motor driven plate movable inside the container for feeding of the toner powder; it can comprise a motor driven screw turnable inside the container for output of toner powder; it can comprise vibration means capable of vibrating the container for feeding of toner powder, and/or it can comprise means for the charging of the supply means with an electrical potential capable of repelling the toner powder and supply powder there through. Further it can be designed as ultra sound vibrator, or vacuum techniques can be used. The use of air as insertion means i.e. over- or under pressure, to insert toner powder in the container can also be considered.

According to further aspects of present invention there is also a device that can execute above mentioned method characterized in that a fixture for fixating a toner cartridge, a passage forming means capable of creating at least one passage through the housing of the toner cartridge, a hollow supply means arranged to a container with toner and in flow communication with the interior of the container, means for arranging said container to the toner cartridge wherein the supply means is inserted into the passage, and feed means capable of supplying powder from the container through the supply means and into the toner cartridge.

The present invention is based on four sections, which are of importance for the method. These are to arrange a passage inside a toner cartridge in order to be able to fill with toner powder, for example by heating or drilling a hole; supply means that permits supply of toner powder into the cartridge, for example with a hollow pipe, feed means for the input of toner powder into the cartridge, e.g. feeding screw, vibrations to shake the powder down or gravity; and to arrange a sealing of the passage, which can be arranged before or after the input of toner powder into the cartridge, for example a check valve, tape or plug.

The present invention has a number of advantages versus present technology. With the method according to the invention the refilling of toner cartridges is simplified when a passage is created the first time the toner cartridge is to be refilled and that a thin insertion means is inserted into the passage for the refilling of toner powder. The small passage can thereafter easily be sealed with e.g. a plug or tape etc. In the case of a plug, it can be designed with some form of resealable opening such as a check valve solution that permits passage for the supply means, but which seals the passage when the supply means is removed. Preferably a docking station is used, wherein the passage that was created before the initial refilling will be placed in the same position during subsequent refillings, whereby it is simple to insert the supply means into the previously created passage. It should however be understood that new passages can be made in other places in the cartridge. To further simplify the creation of the passage, the passage forming means can be heated, which melts the plastic somewhat around the supply means. It is also possible to utilize some form of a drilling device to create the passage. Also the plug, if this kind of solution is used, can be mounted by virtue of the device according to the invention, i.e. after a passage has been created the plug can be pushed in manually or automatically before or after refilling.

Since the container containing toner is arranged with the hollow supply means it can be inserted into the passage directly without the hazard of powder spreading into the environment. Further, the passage is of approximately the same thickness as the supply means so the risk of toner powder leaking out that way is essentially reduced. The risk of powder in the surroundings is further prevented due to that the opening after refilling can be closed by means of a plug, tape, screw or the like. If a check valve is used then there is no use for the later sealing devices. Also the check valve can be arranged in the passage before the supplying of toner powder.

The supply means can be designed in a number of different ways that are suitable for transferring toner powder from the container to the interior of the cartridge.

These and other aspects of, and advantages with, present invention will be apparent from the detailed description of the invention and drawings.

### SHORT DESCRIPTION OF THE DRAWINGS

In the following detailed description of the invention reference will be made to the drawings, where

FIG. 1 is a perspective side view of an example of an embodiment of the present invention,

FIG. 2 is a perspective side view of the device according to FIG. 1 mounted on a wall surface,

FIG. 3 displays a detailed view of the mechanics of the device according to FIGS. 1 and 2,

FIG. 4 displays an example of sealable insert of the “check valve type” along with a supply means,

FIGS. 5 and 6 display examples of two embodiments of the sealable insert according to FIG. 5,

FIGS. 7 and 8 display alternatives for sealing devices,

FIGS. 9 and 11 display alternatives for drive devices for the supply of toner powder,

FIG. 12 is a perspective side view of an example of a hole making means that is included in present invention,

FIG. 13 is a cross-sectional view of the hole making means according to FIG. 12,

FIG. 14 is a perspective side view of a refilling means that is included in present invention,

FIG. 15 displays a cross-sectional view of an embodiment of a supply means that is included in present invention,

FIG. 16 displays the supply means according to FIG. 15,

FIG. 17 displays another embodiment of a supply means, and

FIG. 18a, b display yet another embodiment of a supply means.

### DETAILED DESCRIPTION OF THE INVENTION

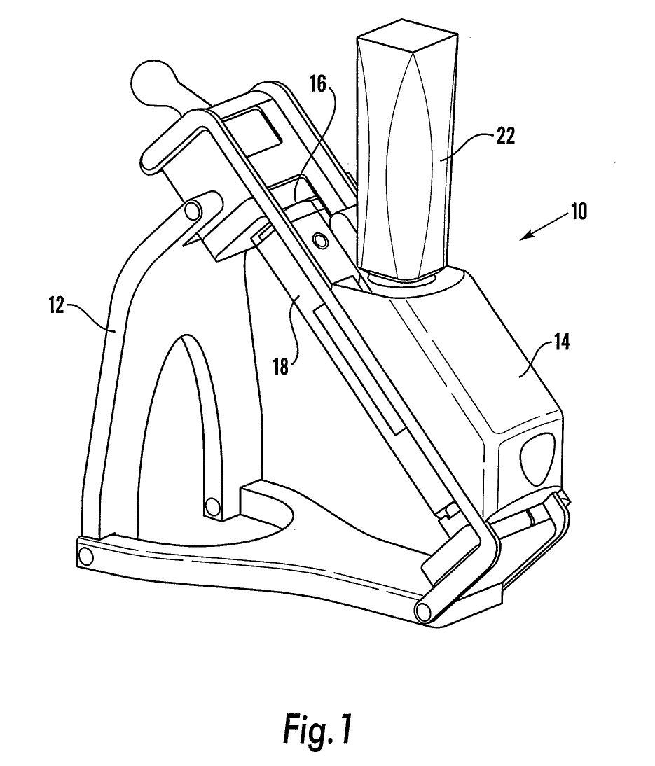

FIG. 1 displays an example of a device 10 for the refilling of a toner cartridge.

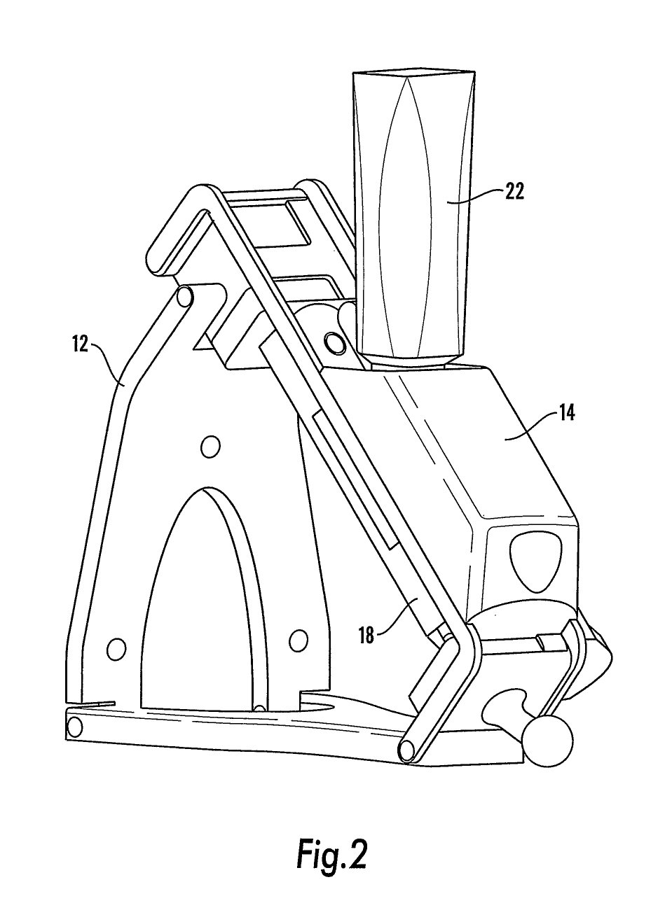

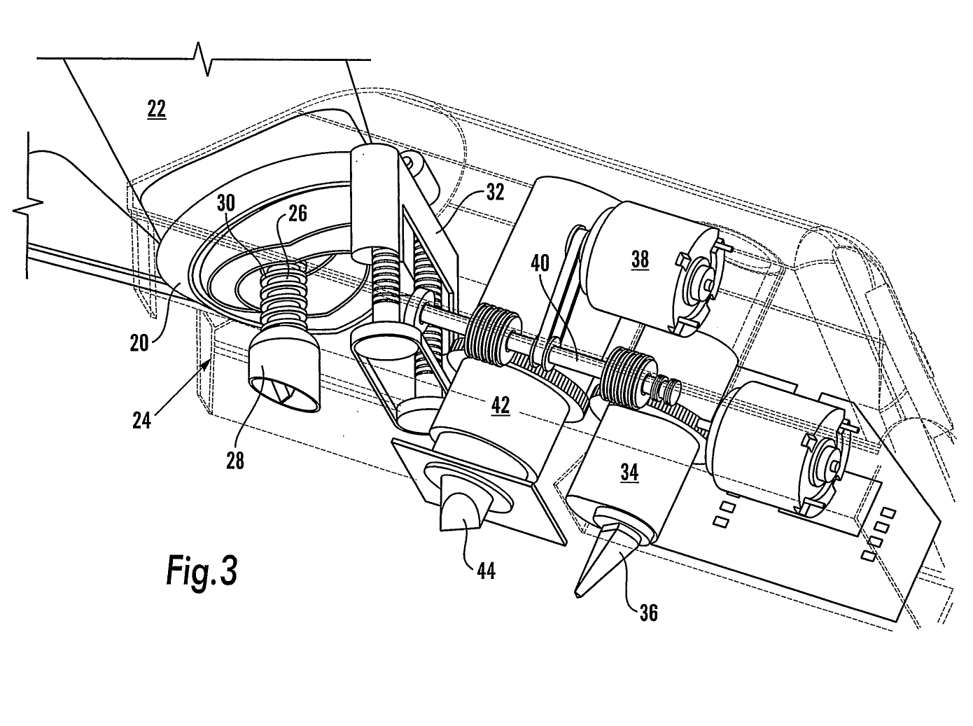

The device comprises a bracket 12 designed and intended to hold the toner cartridge in a certain position. The bracket is designed as a stand wherein the device can be placed on a flat surface such as shown in FIG. 1. The stand can also be attached to a wall surface according to FIG. 2. The device further includes a refilling unit 14 that is slidable in the direction of the arrows along a slide track 16. The refilling unit contains the mechanics for the execution of refilling. A toner cartridge, not shown, can removably be attached to the stand beneath the refilling unit via the cartridge bracket 18. FIG. 3 shows an example of how the refilling of toner powder can be executed. The entire refilling unit 14 is as mentioned slidable in relation to the stand and therefore also the mounted toner cartridge in a way that will be described further below. The refilling unit includes a bracket 20 for a container 22 which contains toner powder that shall be refilled in a toner cartridge, which container has corresponding design to be mounted to the bracket of the refilling unit. The bracket is further arranged with a supply means 24, in the embodiment shown a pipe 26 that can communicate with the interior of the toner cartridge. At the end of the supply means a sealing case 28 is slidably arranged along the pipe, and with a spring 30 that forces the sealing case 28 against the lower end of the pipe. A feed means 32 is further arranged to the bracket and container, in the embodiment shown a mechanical vibration device.

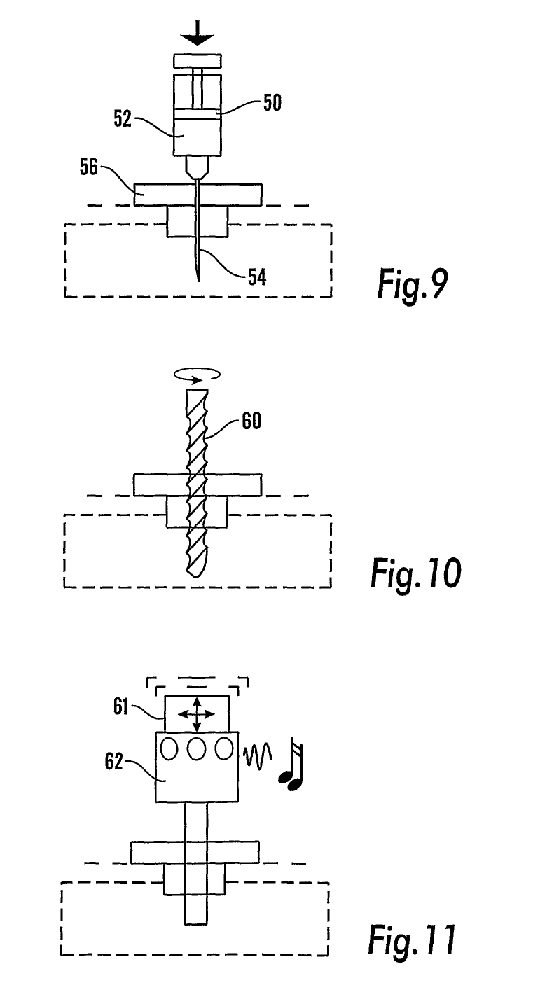

The feed means can of course also include other types of solutions. Examples of such are shown in FIGS. 9 through 11. FIG. 9 displays the supply means as a mechanical pressure device including a piston 50 in a cylindrical space 52 filled with toner powder. The feed means is here shown as a needle 54 that is inserted through the cartridge and through which toner powder is pushed. The cartridge can be designed with a sealing plug 56, which will be described further in detail below. FIG. 10 displays a feed means in the shape of a mechanical supply screw 60, and FIG. 11 displays a feed means in the shape of a mechanical 61 or ultrasound vibration device 62. Other suitable variants, though not shown, are vacuum- or over pressure devices, or that the supply means is charged positively or negatively and that it thereby will repel the toner particles depending on what charge these have, which creates a flow of toner particles through the supply means. Further, the use of gravity, if the passage is made large enough, is possible, as a supply means, i.e. that a valve is opened when the cartridge is to be refilled and the toner powder falls from the container down through the insertion means and into the cartridge.

The refilling unit further includes a means to insert a sealing device 42 in the created passage. An example of sealing device will be described below. Even the sealing device can be driven by the electric motor via the transmission. Further, there is electronics in the refilling device to power and control the separate parts of the mechanics.

When a cartridge is to be refilled it is placed in the bracket 18 so that it obtains a certain position in relation to the refilling unit. Then the refilling unit 14 is activated whereby it is placed in the glide track 16 of the stand 12. As has been mentioned above the movement occurs when the motor inside the refilling unit is activated whereby it drives the unit along the glide track. It should be understood that this also can be preformed manually by pushing the unit to a certain position by hand. The refilling unit is now in position to fill the cartridge with toner powder. The refilling unit is activated whereby it is moved along the glide track, either automatically or manually, until the supply means is placed in the correct position above the insert.

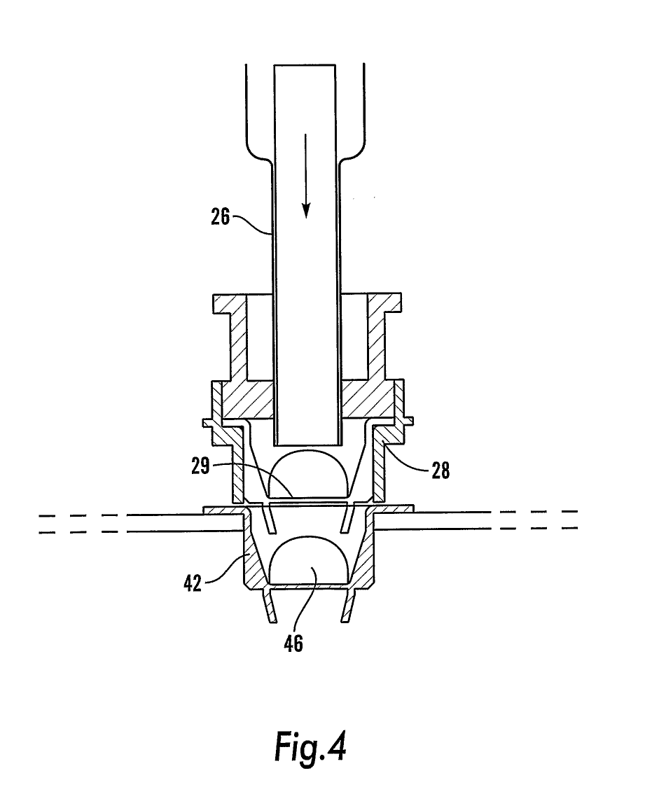

The supply means is fed down towards the insert, FIG. 4, wherein the pipe 26 is pushed into a passage earlier created inside the cartridge so that the supply means 26 is pushed into the interior of the cartridge. Thereby a passage between the toner container and the cartridge is created. When the supply means has been fed down through the insert the sealing case 28 will be in contact with the cartridge and be pushed against it due to the spring. This provides a protection against powder escaping into the surroundings. Now the feed means 32 is activated, in the depicted embodiment a mechanical oscillating device, wherein toner powder is “shaken” down into the cartridge. Filling the cartridge with toner powder first to then arrange a sealing of the passage is also possible.

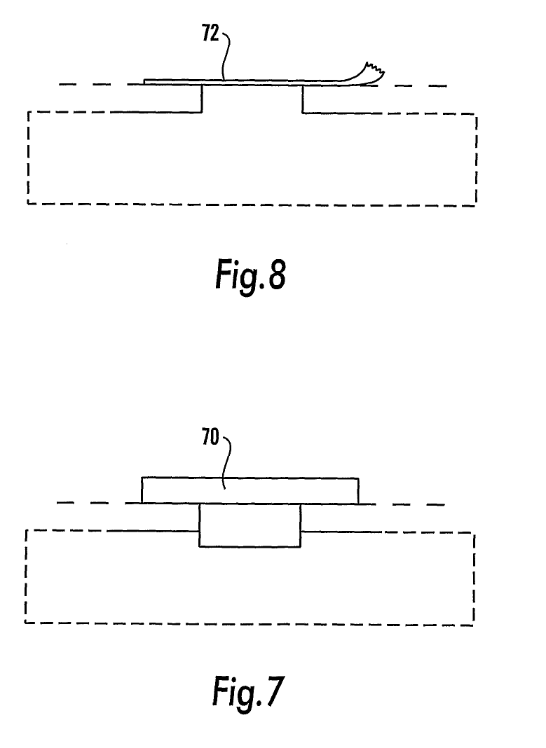

When the refilling process is complete the feed means stops, the supply means is retracted and the cartridge is ready to be placed into the intended duplication apparatus. In this context is should be understood that the sealing of the passage can be done in other suitable ways. For example can an ordinary plug 70, FIG. 7, be pushed into the passage manually or automatically by the device, which plug must be removed next time the cartridge is to be refilled. Some form of self-adhesive tape 72, FIG. 8 or similar lid to close the passage is also possible.

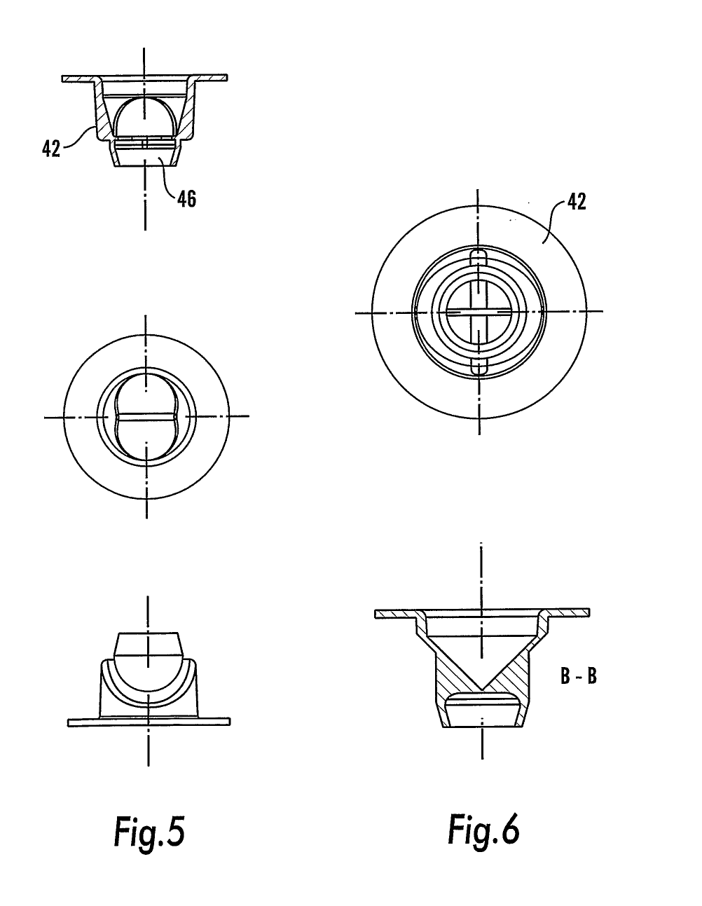

Instead of a plug, tape or the like an insert can be mounted inside the passage. The refilling unit can then be moved along the glide track until the means for insertion of the insert 42 is in the right position in relation to the passage. This movement also can occur automatically or manually. The insertion means is fed towards and pushes the insert 44 into the passage. In this context the insert is preferably made of some elastic material such as rubber or plastic. The insert could also be arranged with some form of adhesive such as glue, self-adhesive tape or the like, to attach the insert to the cartridge. The insert could for example be of “check valve type”. The FIGS. 5 and 6 shows an example of one such insert that is inserted into the cartridge and there is attached to the cartridge wall. The insert is for example, as shown in the figure, provided with at least one set of resilient lips 46 as sealing. Of course the insert can be designed in a number of ways that allows a sealing function. The lips are in an unaffected state resiliently in contact against each other and directed inwards the interior of the cartridge wherein they seal tight. In this context the supply means can also be provided with a set of sealing lips 29 that are opened when the supply means is inserted into the cartridge. When the supply means is removed after the refilling of toner powder, the lips inside the insert spring back and close the passage.

It is also possible that refilling occurs by opening the cartridge at some suitable place and way in order to insert into the opening the feed means and thereby inserting the toner powder, whereafter the cartridge is closed. In this case a sealing device is not needed.

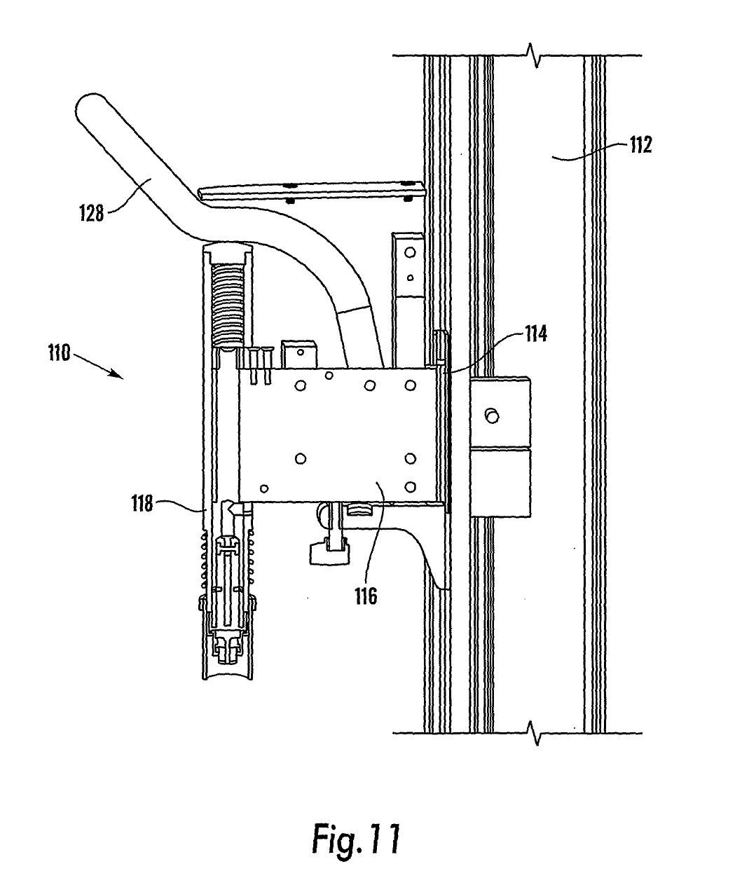

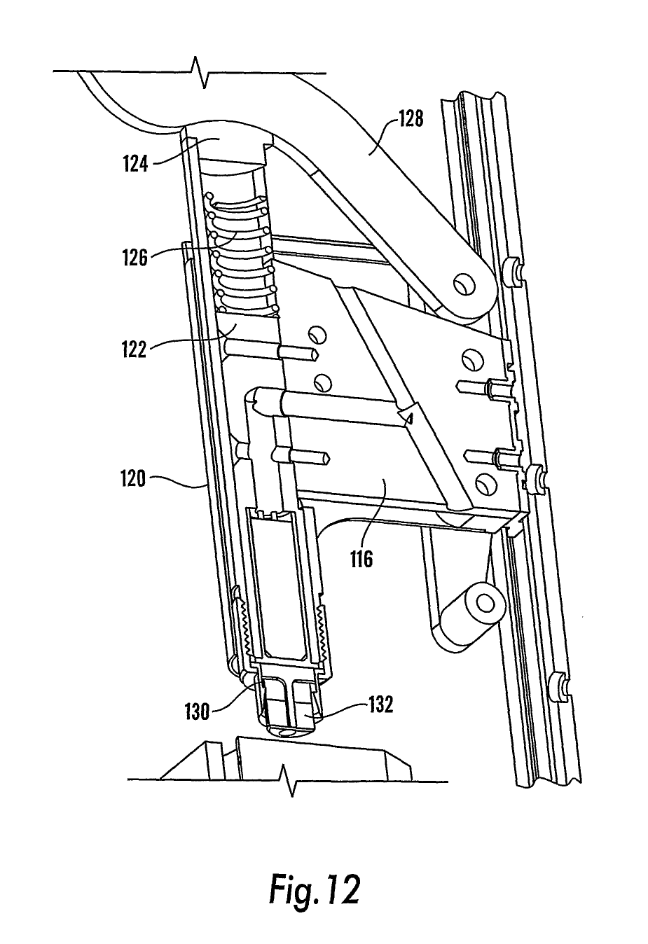

The FIGS. 12 through 14 show an alternative embodiment of the present invention. In FIG. 12 a hole making means 110 is shown that is included in present invention. This includes a pillar of e.g. aluminum mounted on a table or similar work-refilling place (not shown). A bracket 114 is slidably arranged in a track inside the pillar. The bracket can be locked in any desirable place along the track with a lock means. On the bracket an arm 116 is attached and to the front end of the arm a hole making means 118 is arranged, capable of making a hole in a toner cartridge.

The hole making means comprises an elongated cylindrical body 120 that is slidably arranged around a guide member 122 via a slot in the cylindrical body. The upper part of the cylindrical body is arranged with a stop plug 124 and a coil spring 126 is arranged between the guide member and the stop plug. An operating arm 128 hingedly attached to the arm and designed to act on the stop plug and thereby the cylindrical body when the operating arm is pushed down.

The hole making means further includes a heat hole maker 130 with cylindrical form that when in its heated state creates a hole in the cartridge. In the middle of this hole maker a holding device 132 is arranged, which holds the heat removed part.

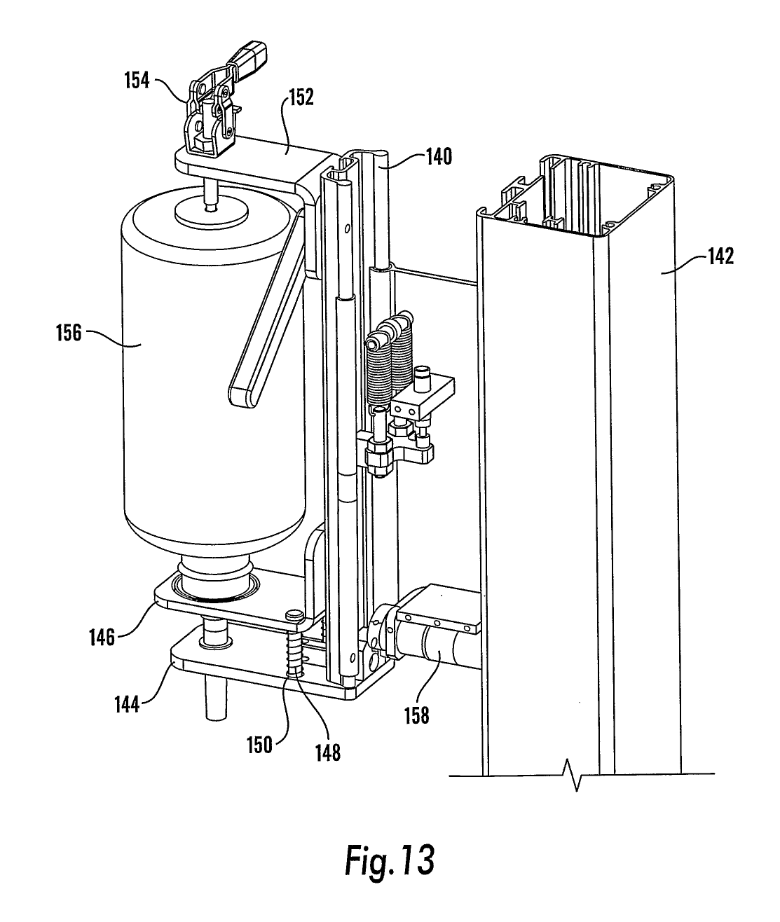

FIG. 14 shows the refilling device according to present invention. This includes a stand 140 that is slidably arranged on a profiled aluminum rail 142. The stand includes a first lower plate 144 fixedly attached, with one through-going hole. The stand further includes a second lower plate 146, also this with a through-going hole and movable in the vertical direction via guide pins 148, which also are arranged with springs 150 to push the plate upwards. The stand includes also an upper plate 152 that is slidable in the vertical direction and is lockable in selective position. The upper plate is further arranged with a clamping member 154 for the clamping of a bottle 156 with toner powder. An electrical motor 158 with an eccentric is arranged to the stand, the function of which will be described below.

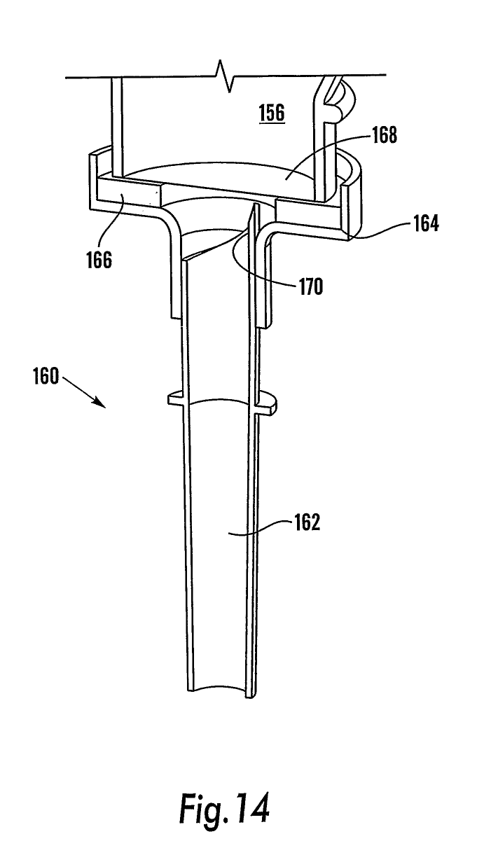

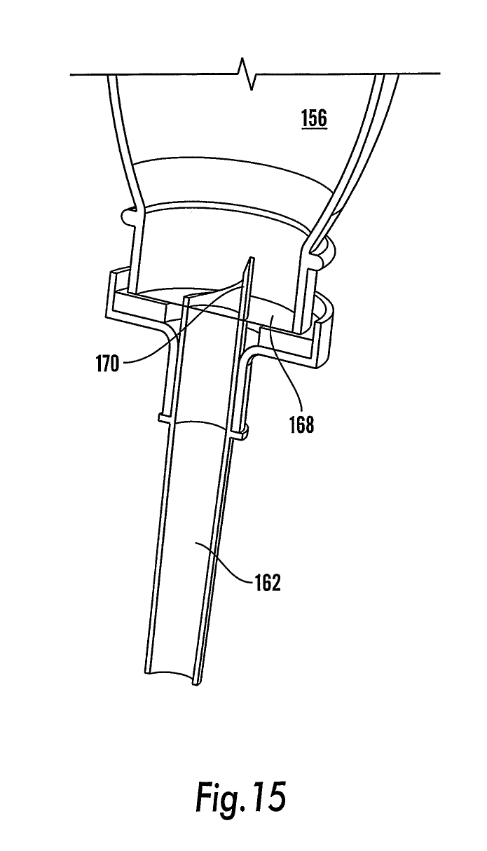

The refilling bottle 156 containing toner powder is arranged with a supply means 160 in the shape of an elongated pipe 162 and a mounting part 164, FIGS. 15 and 16. The mounting part 164 has a diameter that corresponds to the diameter of the opening of the bottle and arranged with a sealing ring 166, which preferably is arranged with an adhesive layer so that the fixing part attach to the mouth of the bottle. The bottle is further arranged with a sealing layer 168 when it is delivered, so that toner powder is unable to spread into the surroundings. The rear part 170 of the elongated pipe is thereby shaped with a beveling wherein a pointed part is formed. The elongated pipe is also slidably arranged in the mounting part.

The device is intended to function as follows. When a toner cartridge is to be refilled for the first time, the cartridge is placed in a fixture that holds it in a position in relation to the hole making means 110. The hole making means is then pushed down towards the toner cartridge and the operating arm moves the hole maker down towards the cartridge. The current is switched on wherein the hole maker 130 is heated. When the heated cylindrical body is moved towards the wall of the cartridge it melts the plastic, wherein an opening is created. The holding part 132 in the middle of the perforating means ensures that the melted section from the opening doesn't fall into the cartridge.

Now that a passage has been created the cartridge is removed from the fixture and is placed in the refilling station where it is fixed in the correct position. A refilling container 156 with toner powder is provided and is provided with a supply means 160 where the mounting part 164 is attached on the neck edge of the bottle. The bottle is then placed in the stand where the elongated pipe of the supply means is brought through the through-going holes of the lower plates and is clamped between the movable lower plate 146 and the upper plate 152 by means of the clamping device 154.

The stand with the bottle is now brought along the rail until the elongated pipe is conducted into the opening that has been created in the cartridge. The diameter of the pipe increases somewhat in the vertical direction and is matched by the diameter of the opening so that the pipe after a certain insertion section abuts against the ledge of the opening and is stuck there. A further movement of the bottle towards the cartridge makes the pipe move upward in relation to the bottle. The upper beveled part 170 of the pipe will now cut through the sealing layer and thereby create a passage between the interior of the cartridge and the interior of the bottle.

The electrical motor 158 with the eccentric is now started wherein the stand will vibrate in the vertical direction. This vibration entails that toner powder in the bottle will be shaken out through the pipe of the supply means and feed into the cartridge. When the refilling has ended the cartridge is removed and the opening is provided with a suitable sealing device. This can be a self-adhesive etiquette, a plug that is pushed into the opening, or some other suitable means. The cartridge is now ready to be used again.

Even if it has been described that the cartridge is moved between different stations it should be understood that the perforation and refilling can be done with suitably designed and arranged means without moving the cartridge. It should also be understood that a cartridge that previously has been refilled with present invention does not need to be perforated again. It is enough that the sealing means is removed from the passage and that the cartridge is placed in the refilling station. In this case the sealing means can be designed with a type of check valve so that the elongated pipe can be slid through the sealing means to create a passage, but when it is removed the passage closes again.

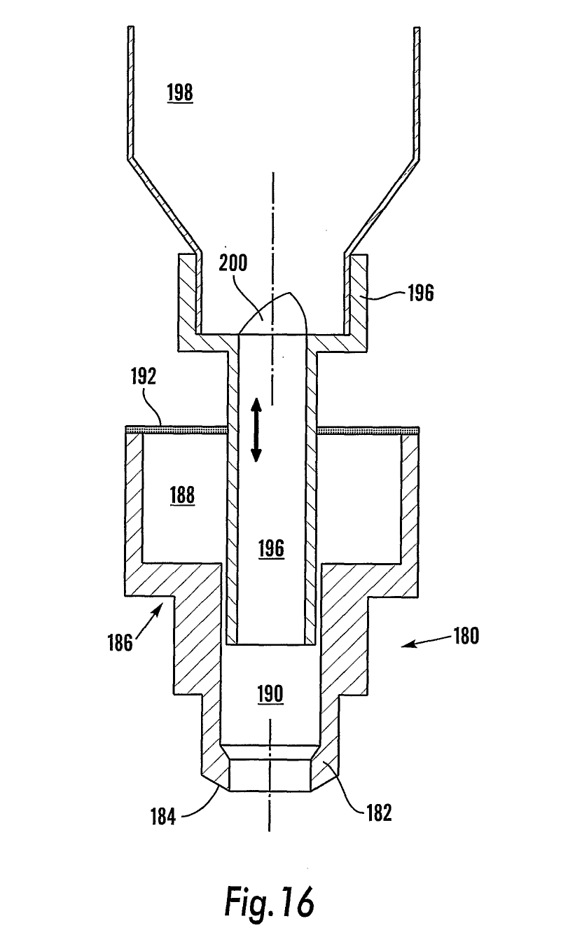

FIG. 17 shows an alternative of the supply means. This includes a lower mouthpiece part 180. It has a lower tube shaped section 182 with a beveling 184 designed and intended to abut against the ledge of the passage that has been created in the toner cartridge (not shown). The mouth piece section is attached to the plate 144, whereby the mouth piece section preferably is designed with a contact ledge 186. The upper part of the mouth piece section has a greater diameter and contains a space 188, which narrows into a passage 190 in the lower tube shaped part that leads out downward. Around the upper edge of the mouth piece section an elastic membrane 192 is attached, which is arranged with a central hole.

The alternative further includes an upper mouth piece section 194 in the shape of an elongated pipe 196 with a diameter that is somewhat smaller than the passage 190. Further, the upper mouth piece section 194 is arranged with an attachment means 196 for applying it to the neck of a bottle or container 198 that contains toner powder. Preferably the attachment means is in the shape of a sleeve that can be slid onto the neck of the container. Also, any sort of adhesive or double-sided tape can be arranged between the edge of the neck and the oppositely directed surface of the attachment means. As with the earlier variants, the upper mouth piece section is preferably provided with a cutting means 200 in the shape of a sharp edge that can cut through the sealing foil that is arranged to the neck of the container.

As has been described earlier the container 198 is mounted to the vibrating section wherein the elongated pipe 196 will move up and down in the lower mouth piece section 180, wherein toner powder is shaken down through the pipe and into the toner container. The flexible membrane 192 ensures that no toner powder can escape into the surroundings while permitting movement of the pipe. The space 188 within the membrane is utilized for receiving the air that is carried out of the toner cartridge when the powder is introduced.

The above described supply means and mouth piece sections can be made of a number of different materials depending on desires. For example they can be disposable and from environmental aspects it is preferred if at least parts of the supply means is made out of cardboard or otherwise cellulose based material. On the other hand the insertion means can be produced out of materials that make them very durable and can easily be cleaned inbetween refillings, such as for example stainless steel or aluminum.

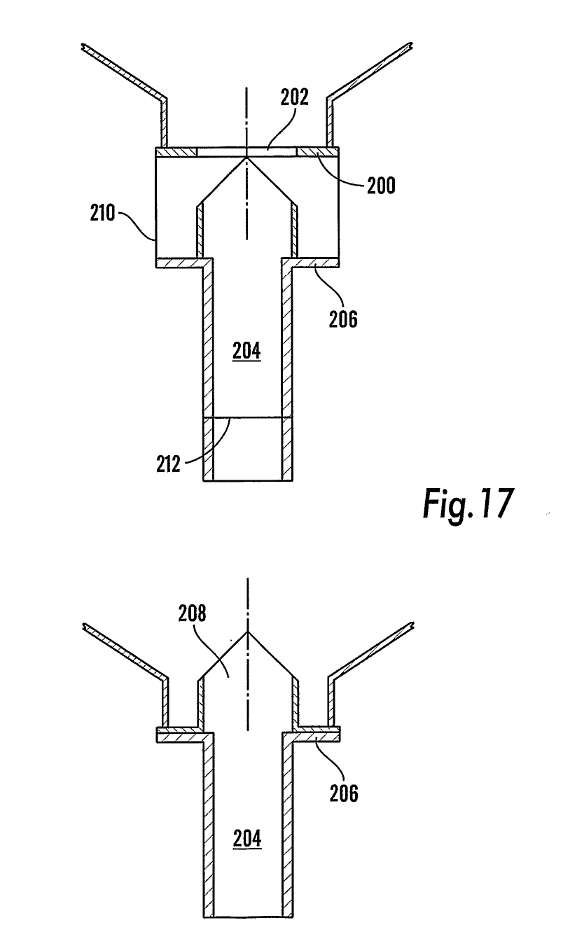

One example of an upper mouth piece section of disposable type is shown in FIG. 18a, b. The neck ledge of the bottle is preferably provided with a sticky paste 200 with protective foil that is removed before use, alternatively a double-sided tape with protective foil. Underneath the sticky paste a sealing foil 202 is applied to the neck edge, which ensures that toner powder can not spread into the surroundings. The insertion tube 204 is made of cardboard with a brim 206. On the brim, alternatively that the tube goes in through the brim, a sharpened tube part 208 is arranged, which is capable of penetrating the sealing foil when the upper mouth piece section is pushed towards the neck. Further, a sleeve of paper 210 or similar is attached to the ledge of the brim, which sleeve is compressed when the mouth piece section is pressed against the bottle. Sticky paste 200 or the double-sided tape sees to that the brim 206 and thereby the mouth piece section sealably attaches against the neck ledge. The bottle is now ready to be used for refilling of a toner cartridge. When the refilling then is done the passage through the mouth piece section can be closed by for example that the cardboard tube 204 is provided with a distress notch 212 where the tube can be bent and the passage sealed.

It should be understood that the embodiments of the invention that has been described above and shown in the drawings only are to be regarded as non-restricting examples of present invention and that it is defined by the scope of protection of the patent claims.

1. Method for filling a toner cartridge, intended for duplication apparatuses, with toner powder comprising the steps of:
placing the toner cartridge in relation to a device for refilling,
inserting a hollow supply means through a passage in the cartridge and into the interior of the toner cartridge, which supply means is applied to a container containing toner powder and in flow communication with the interior of the container, and
by means of feed means feed the powder from the container through the supply means and into the toner cartridge.

2. Method according to claim 1, characterized in that the feed means comprises a motor-driven plate movable in the container for feeding of toner powder.

3. Method according to claim 1, characterized in that the feed means comprises a motor-driven screw turnable in the container for the feeding of toner powder.

4. Method according to claim 1, characterized in that the feed means comprises vibration means capable of vibrating the container for the feeding of powder.

5. Method according to claim 1, characterized in that the feed means comprises means for the charging of the supply means by means of an electrical potential capable of repelling toner powder and thereby feeding of powder.

6. Method according to claim 1, characterized in that the feed means comprises air means for the creation of overpressure or underpressure.

7. Method according to claim 1, characterized in that the passage is created by opening the cartridge.

8. Method according to claim 1, characterized in that the passage is a previously created hole in the cartridge.

9. Method according to claim 1, characterized by a sealing and closing means intended to be arranged in the passage.

10. Method according to claim 9, characterized in that the sealing and closing means are provided with resilient sealing means that permits insertion of the supply means during subsequent input of toner powder.

11. Method according to claim 10, characterized in that the resilient sealing and closing means are designed as lips of a elastic material.

12. Method according to claim 1, characterized in that the sealing and closing means is a tape, plug, screw or similar capable of sealing the passage during attachment thereto.

13. Device for executing the method according to claim 1, characterized by a hollow supply means attached to a container with toner and in flow communication with the interior of the container, means for arranging said container to the toner cartridge wherein the supply means is inserted in a passage in the container, and feed means capable of feeding powder from the container through the supply means and into the toner cartridge.

14. Device according to claim 13, characterized in that the feed means comprises a motor-driven plate movable in the container for the feeding of toner powder.

15. Device according to claim 13, characterized in that the feed means comprises a motor-driven screw turnable in the container for the feeding of toner powder.

16. Device according to claim 13, characterized in that the feed means includes vibration means capable of vibrating the container for the feeding of powder.

17. Device according to claim 13, characterized in that the feed means comprises means for the charging of the supply means with an electrical potential capable of repelling the toner powder and thereby feed powder.

18. Device according to claim 13, characterized in that the feed means comprises air means for the creation of overpressure or underpressure.

19. Device according to claim 13, characterized by a sealing means intended to be placed in the passage and provided with resilient sealing means that permit insertion of the supply means during subsequent feeding of toner powder.

20. Device according to claim 19, characterized in that the resilient sealing means is designed as lips of an elastic material.

21. Method according to claim 10, characterized in that the sealing means is a tape, plug, screw or similar capable of sealing the passage during application.

22. Device according to claim 10, characterized in that the device further comprises a fixture for holding the toner cartridge in a certain pre-set position.
